(19) United States
(12) Patent Application Publication
(10) Pub. No.: US 2012/0297931 A1
(43) Pub. Date: Nov. 29, 2012

(54) Sledge hammer head with integral attachment loop

(76) Inventors: Jay Rivard, Edmonton (CA); Eric Clark, Calgary (CA)

(21) Appl. No.: 13/114,513

(22) Filed: May 24, 2011

(51) Int. Cl. B25D 1/00

(52) U.S. Cl. 81/20

(57) ABSTRACT

A head having a metal loop is provided for use in a sledgehammer. A sledge hammer having a head with an integral, forged loop is also provided, as is a combination of the sledge hammer and an attachment means such as a carabiner. The head, with the loop are forged as a unit.

### FIELD

The present technology is related to a modified hammer head that provides a means for attaching the hammer to a user. More specifically, the technology is a hammer head having an integral loop for attaching a carabiner or the like.

### BACKGROUND

Most sledge hammers used by ironworkers are heavy, weighing between 4 lbs and 10 lbs. Such weight is necessary in order for the hammer blow to be of sufficient force.

Ironworkers often work at heights, hence dropping such a heavy hammer could have catastrophic consequences. Surprisingly, therefore, the hammers are not securely retained when not in use. Instead, they are transferred to the workers pouch or belt and are retained either by an external clip or by tucking them into the pouch. This means that there is no positive engagement between the hammer and the worker.

In an attempt to rectify the problem of a poorly retained tool, a device to retain iron worker tools is disclosed in US Publication No. 20070215657. The Model T. Sleever Bar Holder is a new carrier/keeper for a specific tool, the Sleever bar tool. The Model T. Sleever bar holder swivels 360 degrees. A leather loop attached to the steel plate allows the Sleever bar holder to slide easily on to an existing tool belt.

Hammers and ice axes have been disclosed that have at least one hole in the head. These are to reduce weight, or reduce vibration. For example, in US Publication No. 20100116096 it is stated “Cavity 125 preferably serves to reduce a total mass of head 120 and to reduce transmission and/or creation of vibrations as may occur from striking impacts.” Similarly in U.S. Pat. No. 5,937,466 it is stated “As shown in FIG. 1, the head portion 14 of the ice axe 10 has a void 42 formed therein. The void 42 decreases the overall weight of the ice axe 10 and decreases the energy expended during use. The void 42 also forms a convenient place to attach a wrist leash or a carabiner. Because of this, such voids have become common in currently available ice axe heads.” In another prior art document, U.S. Pat. No. 7,051,390 a hole is provided in the head for hanging a hammer for easy storage.

### SUMMARY

A modified sledge hammer is provided that has a metal loop on the head for positive attachment to the worker or worker's belt or pouch. The head therefore provides increased safety. The head has a loop on a lower side for attachment of a carabiner or other attachment means. In the preferred embodiment the head and loop are integral and further, are forged. As a result, existing dies can easily be modified by grinding out the shape of the loop to produce a forged unit. A further and very significant advantage is that the improved head would not require engineering and certification in order to be used.

### FIGURES

FIG. 1. An isometric view of an embodiment of the present technology.

FIG. 2. An isometric view of the head of the embodiment of FIG. 1.

FIG. 3. An isometric view of a sledge hammer and attachment means of the present technology.

### DETAILED DESCRIPTION:

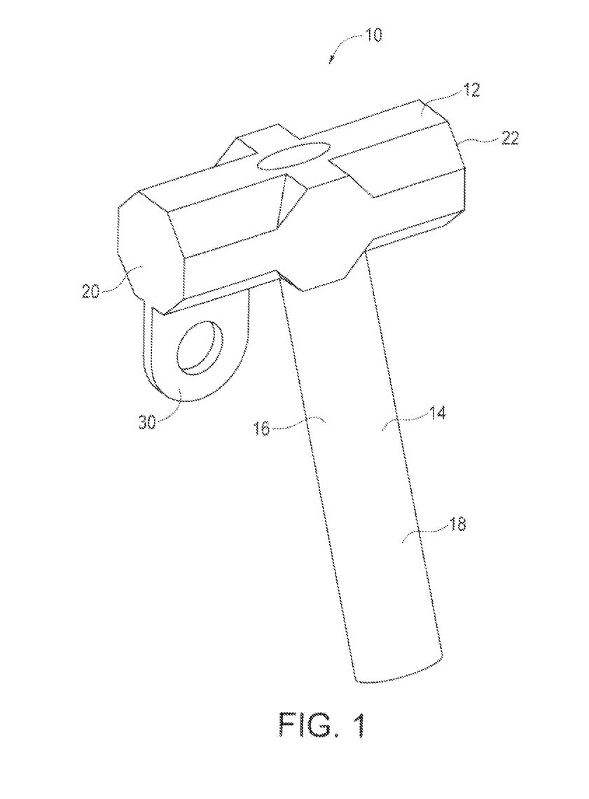

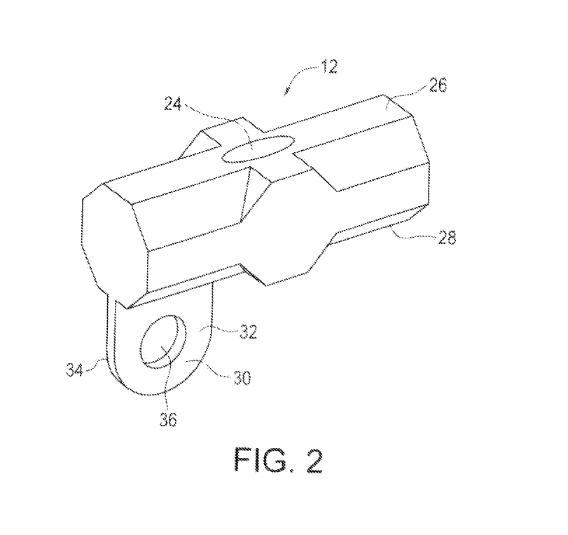

A sledge hammer, generally referred to as 10 is shown in FIG. 1. The hammer 10 has a head 12 and handle 14. Handle 14 further comprises shaft 16 and grip 18. Unlike carpentry hammers, the head 12 of the sledge hammer 10 has essentially blunt ends 20, 22. This, and the mass of the head 12 provides the necessary weight. The head preferably weighs about 1.4 Kg to about 5.5 Kg, more preferably about 1.6 Kg to about 5 Kg and most preferably about 1.8 Kg to about 4.5 Kg. As shown in FIG. 2 the head 12 is octagonal in cross section. A handle aperture 24 is centrally located and passes through the top side 26 to the bottom side 28. As shown in FIGS. 1 and 2, a metal loop 30 extends from the bottom side 28 in the vicinity of the end 20 of the head 12. The loop 30 is preferably forged as a unit with the head 12, however, it may be affixed to the head 12 in a number of ways as would be known to one skilled in the art, including, but not limited to welded to the head 12.

It can be seen that the loop 30 is a flat plate having two sides 32 and a periphery 34. The periphery 34 is preferably between about 20 mm and 1 mm thick, more preferably between about 15 mm and 5 mm thick, and more preferably about 10 mm thick. The plate has a void 36 that is sized to accept a carabiner, for example, it is between about 5 mm to about 25 mm in diameter, preferably between about 20 mm to 10 mm in diameter and more preferably about 15 mm in diameter.

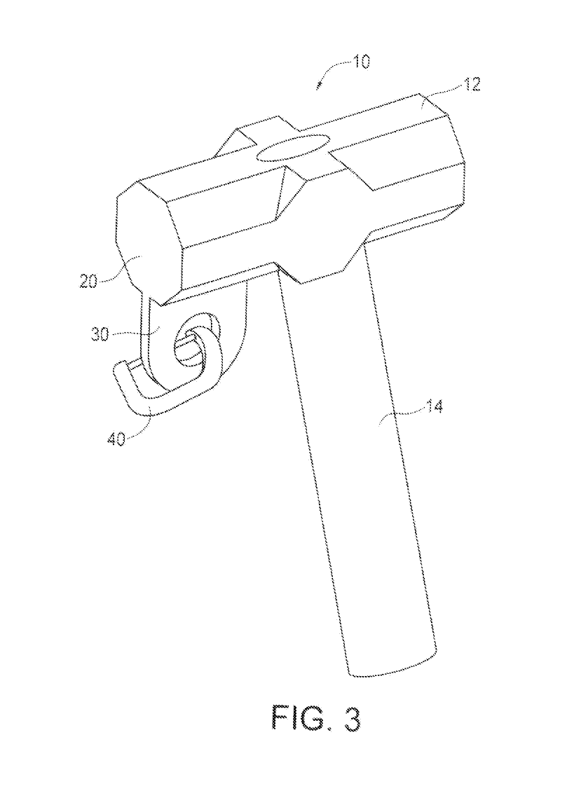

As shown in FIG. 3, a carabiner 40, rope, retractor or other attachment means is used to releasably attach the hammer 10 to the worker, or the worker's tool pouch or belt.

The foregoing is a description of an embodiment of the technology. As would be known to one skilled in the art, variations that do not alter the scope of the technology are contemplated. For example the loop may be on any side, or there may be two loops, each located on any side. Further, the loop need not be flat, as the requirement is that it is able to accept a carabiner or other attachment means.

1. A sledge hammer for use by ironworkers, the sledge hammer having a handle and a head, the head comprising an upper side and a lower side, two ends and a central aperture for accepting the handle, the improvement being at least one metal loop extending from the head in the vicinity of the end of the head on the upper side, wherein the loop comprises:
a flat plate about 10 mm thick the flat plate having two sides and a periphery; and
and a void about 15 mm in diameter.

2. The sledge hammer of claim 1, wherein the head and the at least one loop are forged as a unit.

3. The sledge hammer of claim 1, wherein the at least one loop is on a lower side of the head.

4. The sledge hammer of claim 3, wherein there are two loops.

5. The sledge hammer of claim 4, wherein the loop is between about 1 mm and 20 mm thick.

6. The sledge hammer of claim 5, wherein the loop has a void that is about 5 mm to about 25 mm in diameter.

7. The sledge hammer of claim 6, wherein the head is about 1.8 Kg to about 4.5 Kg 2 Kg to about 5 Kg in weight

8. A combination for improving ironworker safety, the combination comprising:
i) a sledge hammer, the sledge hammer having a handle and a head, the head comprising eight sides, two ends and a central aperture for accepting the handle, the improvement being at least one metal loop extending from the head in the vicinity of the end of the head on at least one side, wherein the loop comprises:
a flat plate about 10 mm thick the flat plate having two sides and a periphery; and
a void about 15 mm in diameter; and
ii) a carabiner.

9. A head for use in a sledge hammer, the head comprising sides, a central aperture, ends and a loop located on a side, wherein the head is forged as a unit.

10. The sledgehammer of claim 1, wherein the loop is welded onto the head.

11. The combination of claim 8, wherein the loop is welded onto the head.

12. The sledgehammer of claim 1, wherein the one loop is directly adjacent one end of the head.

13. The combination of claim 8, wherein the loop is directly adjacent one end of the head.
